(19) United States
(12) Patent Application Publication
(10) Pub. No.: US 2004/0051800 A1
(43) Pub. Date: Mar. 18, 2004

(54) Readout circuit with on-sensor-chip two-dimensional interpolation

(76) Inventor: Chih-Cheng Hsieh, Hsinchu (TW)

Correspondence Address: FISH & RICHARDSON PC, 225 FRANKLIN ST, BOSTON, MA, 02110, US

(21) Appl. No.: 10/325,308

(22) Filed: Dec. 20, 2002

(30) Foreign Application Priority Data
Sep. 16, 2002 (TW) 091121120

(51) Int. Cl. H04N 5/335

(52) U.S. Cl. 348/294; 348/222.1

(57) ABSTRACT

A readout circuit with on-sensor-chip two-dimensional interpolation. The readout circuit includes a plurality of readout units and at least one connection switch. The readout units read received brightness of the pixel units with the same color. Each of readout units includes at least one charge storage device in which stored charge is a received brightness sensed by a corresponding pixel unit. The switch couples the charge storage devices to share the charge between the coupled devices before the stored charge is read out. Thus, an xy-interpolation is carried out in analog domain.

### BACKGROUND OF THE INVENTION

1. Field of the Invention

The invention relates to a readout circuit with on-sensor-chip two-dimensional interpolation, and more particularly, to a readout circuit capable of carrying out an xy-interpolation in analog domain to improve image quality from sub-sampling.

2. Description of Related Art

Various types of image sensors are in use today, including charge-coupled device (CCD) image sensors and complementary metal-oxide semiconductor (CMOS) image sensors. In recent years, to burst semiconductor technologies and applications, CCD image sensors have not been easily integrated with CMOS process peripheral circuitry due to complex fabrication requirements and relatively high cost. However, since CMOS image sensors are formed with the same CMOS process technology as the peripheral circuitry required for operating the CMOS image sensor, such sensors are easier to integrate into a single system-on-chip using integrated circuit (IC) fabrication processes. Using CMOS image sensors, it is possible to acheive monolithic integration of control logic and timing, image processing, and signal-processing circuitry such as analog-to-digital (A/D) conversion, all within a single sensor chip. Thus, CMOS image sensors can be manufactured at low cost, relative to CCD image sensors, using standard CMOS IC fabrication processes. Accordingly, CMOS image sensors have gained significant ground over CCD image sensors in many applications, especially where integrated functionalities are advantageous, such as in security, biometrics, and industrial applications. Additionally, low power requirement and xy-addressing feature of CMOS image sensors further provide much lower manufactured cost. Also, such CMOS image sensors have been of great impact because they perform real-time image-processing circuitry on-chip.

FIG. 1 is a schematic diagram of a typical CMOS image sensor chip. In FIG. 1, the chip 10 includes an n×m pixel circuit array 100, a signal readout circuit 130, a programmable gain amplifier (PGA) 150, and an analog-to-digital converter (ADC) 170. Further, the chip 10 can have an internal or external digital signal processor (DSP) 11. As shown in FIG. 1, pixel units PIX11-PIXnm respectively indicate a single pixel circuit. The circuit 130 normally has a line of readout units 131 to read pixel units of the line at a time. Existing readout method in use usually adopt correlation double sampling (CDS) circuit as described in U.S. Pat. No. 6,433,632, U.S. Pat. No. 6,248,991, and U.S. Pat. No. 5,877,715 because CDS circuit can provide low image data requirement and significantly reduce fixed pattern noise (FPN). The PGA 150 then amplifies sampled image signals. The amplified signals are converted by the ADC 170 from analog to digital for further processing by the DSP 11.

To obtain a higher transmission rate, when the chip 10 is used to produce an image with fewer pixels than those of the array 100, the current solution generally adopts sub-sampling or interpolation in digital domain. In an example of a 4-million pixel circuit array to a million pixel image requirement, sub-sampling picks over one of every four adjacent pixels after an ADC digitizes the array's pixels, thereby achieving the requirement. However, interpolating averages every four adjacent pixels as a new pixel after an ADC digitizes the array's pixels, thereby achieving the requirement.

However, the two methods have disadvantages, respectively. An image quality generated by sub-sampling is poor, with, for example, discontinuous lines, affecting viewing. An image generated by interpolation can have better quality but requires a lot of memory to process data for computation and consumes more hardware resources. Additionally, interpolation requires a DSP with higher clock rate to receive and process digital data from its connected ADC.

### SUMMARY OF THE INVENTION

Accordingly, an object of the invention is to provide a readout circuit capable of quickly producing interpolated images without additional memory.

Another object of the invention is to provide a readout circuit with on-sensor-chip two-dimensional interpolation in digital domain to produce interpolation data without a DSP.

The invention provides a readout circuit with on-sensor-chip two-dimensional interpolation. The readout circuit includes a plurality of readout units and at least one connection switch. The readout units read received brightness of the pixel units with the same color. Each readout unit includes at least one charge storage device in which stored charge is a received brightness sensed by a corresponding pixel unit. The switch couples the charge storage devices to share the charge between the coupled devices before the stored charge is read out. Thus, an xy-interpolation is carried out in analog domain.

The invention also provides a photo sense module. The module includes a pixel circuit array, a readout circuit, a connection switch, a programmable gain amplifier (PGA) and an analog-to-digital converter (ADC). The pixel circuit array includes a plurality of pixel units in an array to detect a single color-received brightness. The readout circuit with an optionally two-dimensional interpolation reads out the brightness. Every readout unit in the readout circuit corresponds to one of the pixel units. Every readout unit has at least a charge storage device in which stored charge is a relative received brightness of a pixel unit. The readout circuit has a connection switch coupled between the storage devices, to share the charge between the connected devices before the stored charge is read out. The PGA amplifies the signal read by the readout circuit. The ADC converts the amplified signal from analog to digital for use in a subsequent DSP. As cited, an xy-interpolation is carried out in analog domain.

The storage devices are a plurality of register capacitors in the readout circuit. The connection switch is a metal oxide semiconductor (MOS) bridged between two register capacitors.

The invention further provides a method of producing a two-dimensional interpolation image, including reading every received brightness with the same color, sensed by a plurality of pixel units, in a pixel circuit array, and respectively producing a charge to every received brightness for storing charges to corresponding charge storage devices in a plurality of readout circuits, averaging the stored charges in the charge storage devices to produce an average charge, and reading out and converting the average charge into a corresponding plurality of digital signals that forms a two-dimensional interpolation image.

Briefly, before all registered brightness (i.e., stored charge) in the charge storage devices is read out, the charges are averaged. As such, the averaged operation functions as an interpolation. Therefore, a two-dimensional interpolation image is formed after the averaged charge is read out.

### BRIEF DESCRIPTION OF THE DRAWINGS

The invention will become apparent by referring to the subsequent detailed description of a preferred embodiment with reference to the accompanying drawings, wherein:

FIG. 1 is a schematic diagram of a typical CMOS image sensor chip 10;

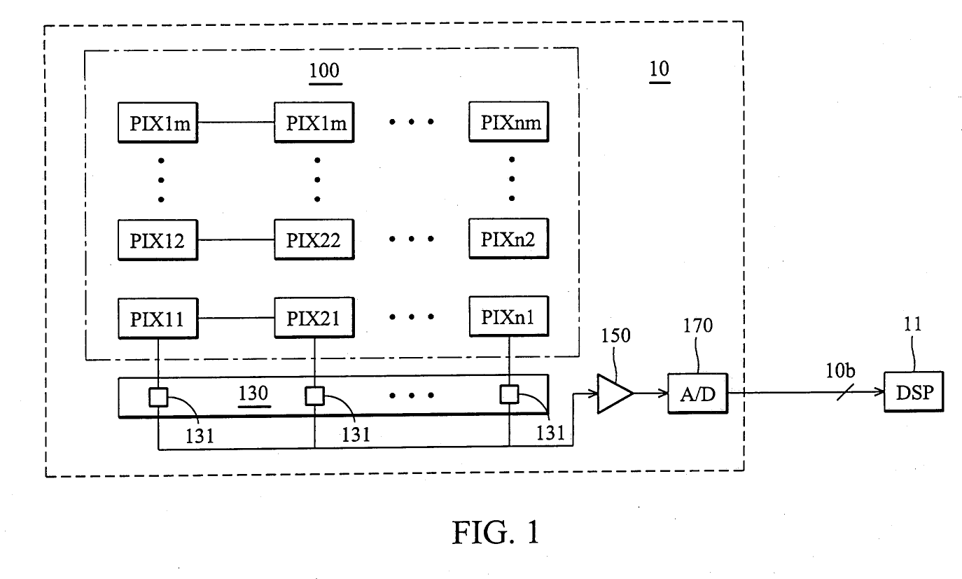

FIG. 2 is a schematic diagram of a CMOS image sensor chip 20 according to the invention;

FIG. 3A is a schematic diagram of a pixel circuit array 100 of FIG. 2 according to the invention;

FIG. 3B is a schematic diagram of a readout circuit of FIG. 2 according to the invention; and

FIG. 4 is a timing diagram of circuits of FIGS. 3A and 3B according to the invention.

### DETAILED DESCRIPTION OF THE INVENTION

Similar elements indicate the same number.

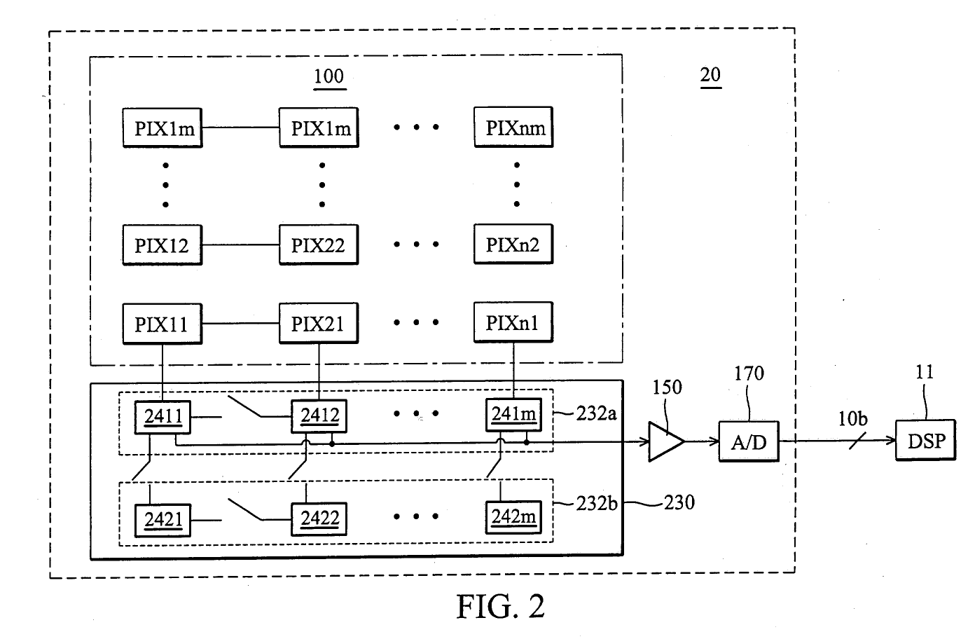

FIG. 2 is a schematic diagram of a CMOS image sensor chip 20 according to the invention. In FIG. 2, the CMOS chip 20 includes a n×m pixel circuit array 100, a readout circuit 230, a PGA 150 and an ADC 180. The chip 20 can internally implement or externally connect to a DSP 11, as shown in FIG. 2. The inventive feature will provide a readout circuit 230 that can perform interpolation in analog domain. It is noted that the circuit 230 has multiple switches to connect for every two readout units.

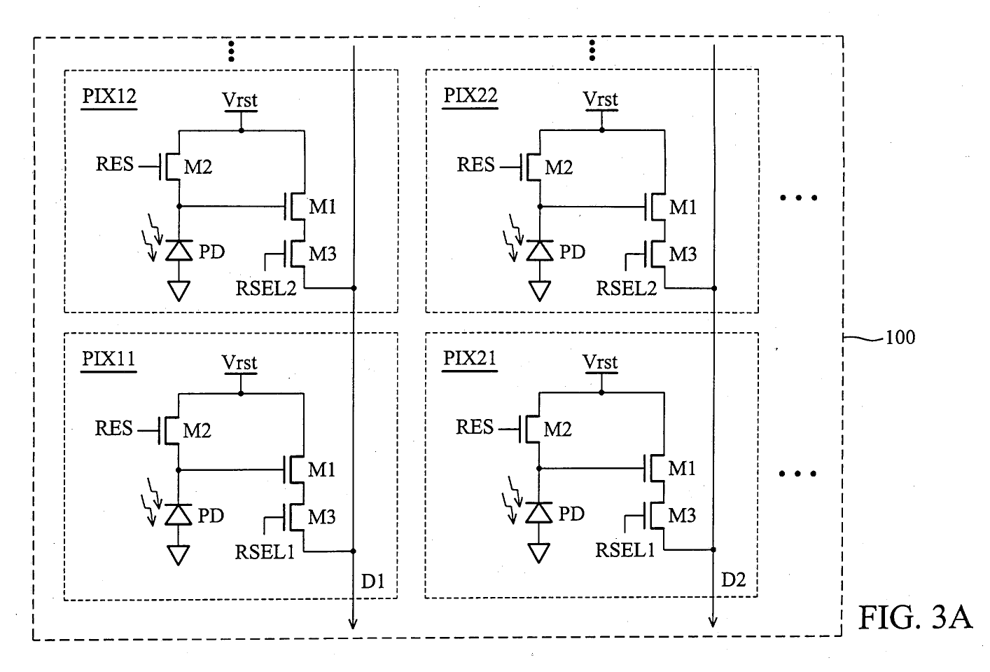

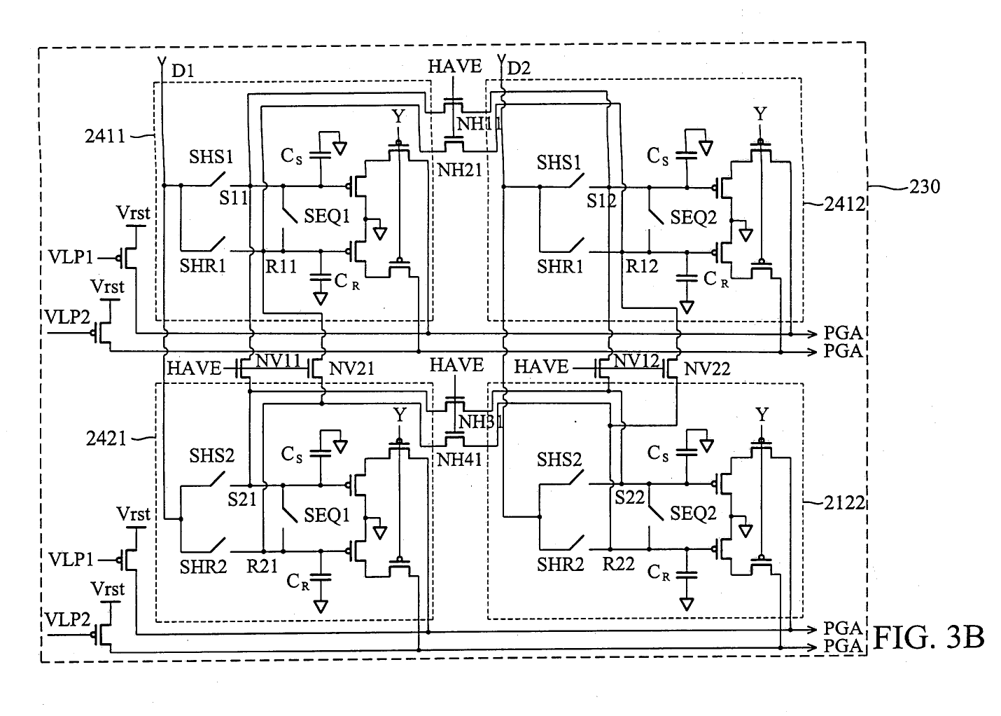

FIG. 3A is a schematic diagram of a pixel circuit array 100 of FIG. 2 according to the invention. In FIG. 3A, every pixel unit has three NMOS transistors and a diode. A NMOS M2 charges (or resets) the diode PD. Another NMOS M1 converts a voltage on the diode PH into a relative current. The resting NMOS M3 control selection of a corresponding pixel unit. The pixel units PIX11 and PIX12 connect to a same column signal line D1, the pixel units PIX21 and PIX22 connect to another line D2, and the like.

FIG. 3B is a schematic diagram of a readout circuit of FIG. 2 according to the invention. In FIG. 3B, the circuit 230 has two rows of readout circuit groups 232a, 232b, each (232a or 232b) having m (column numbers of the pixel circuit array) readout units, as indicated by 2411 to 242m. The received brightness for each row of readout units is read by the well-known correlated double sampling (CDS) technique. The CDS technique can read two states: a charge state to a charging pixel at reset and a leakage state to the charged pixel to be irradiated for a period of time. The difference between the states is proportional to the received brightness that indicates a pixel signal for a pixel unit. The states are converted into the form of charge to respectively store in register capacitor C_{S} and reset capacitor C_{R} in each pixel readout unit. The PGA 150 can be a differential amplifier to read out the difference between the capacitors C_{R} and C_{S}, i.e., read out a pixel signal.

It is noted that multiple switches in the circuit 230 are respectively connected for every two C_{R} or C_{S}. For example, NMOS NH11 couples terminals S11 and S12, and NMOS NV11 couples terminals S11 and S21 and the like as shown in FIG. 3B. In this embodiment, no NMOS connects the capacitors of the units 2421 and 2422.

A switch can optionally connect two capacitors (C_{R} or C_{S}) before charges stored in the capacitors C_{R} and C_{S} are read by the amplifier 150. At this point, the two capacitors have an equal potential to obtain equal charge stored. That is, in FIG. 3B, when a switch connects two capacitors, two capacitors produce equal charge and thus gain two equivalent “interpolation” charges. When the amplifier 150 reads either of the capacitors, it is equivalent to read an “interpolation” brightness produced by received brightness of two pixel units.

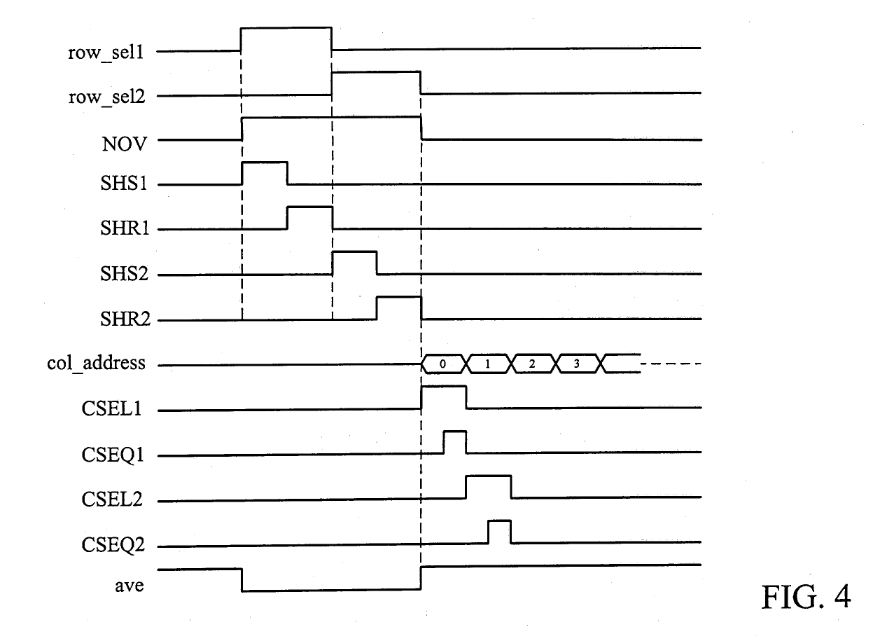

FIG. 4 is signal timing of the circuits of FIGS. 3A and 3B. When signal number of overhead (NOV) is enabled, row_sel1 and row_sel2 individually choose two rows of pixel units in a pixel circuit array. For example, when row_sell and row_sel2 correspond to RSEL1 and RSEL2 of FIG. 3A, pixels of a first row (PIX11-PIX1m) and a second row (PIX21-PIX2m) are selected respectively. When the first row is selected, SHS1 and SHR1 respectively enable the capacitor in the group 232a and the switch between column lines (i.e., connecting the capacitor and the column lines). At this point, the reset state of every pixel unit in the first row and the leakage state of received light corresponding to every pixel unit are in terms of charge respectively to register in C_{S} and C_{R} of a readout circuit unit through the corresponding column lines. Similarly, when the second row is selected, the reset state of every pixel unit in the second row and the leakage state of received light corresponding to every pixel unit are in terms of charge respectively to register in C_{S} and C_{R} of a readout circuit unit in the group 232b through the corresponding column lines. SHS1 and SHR1 respectively enable the capacitor in the group 232a and the switch between column lines. Thus, two groups 232a and 232b respectively register the reset states and the leakage states of the two pixel units.

In FIGS. 3B and 4, signal ave is equivalent to a reverse of signal NOV and to signals VAVE and HAVE. Disabled signal NOV is equivalent to enabled ave and thus it can turn every switch between two readout circuit units on/off. As above, the total brightness of the units 2411, 2412, 2421 and 2422 are equalized due to charge sharing. Similarly, the total brightness of the units 2413, 2414, 2423 and 2424 are equalized (not shown). As such, data stored in every readout circuit unit is changed to a received brightness after interpolation, not an original received brightness.

Signal CSEL1 enables the amplifier 150 to read the charges stored C_{S} and C_{R} of the unit 2411 and then signal CSEQ1 (to control the switch SEQ1 in the unit 2411) resets C_{S} and C_{R} back to original state. Similarly, the interpolation brightness in the group 232a is read by the amplifier 150 in further use for the subsequent converter 170 and DSP chip 11.

Accordingly, received brightness is averaged in every four pixel units and thus a same interpolation brightness is generated to the four pixel units before an output action is performed. The interpolation brightness is an interpolation pixel signal. Next, The DSP chip 11 picks one for every four pixel units as an image pixel and thus an image with fewer pixels and lower distortion is realized.

It is noted that the circuit shown in FIG. 3B can perform the interpolation, but the interpolation is enabled by the signal ave, which is a reverse signal to the signal NOV in the prior art. For implementation in practice, an inverter is used to convert the signal NOV to the signal ave. This is convenient for control.

The aforementioned method and circuit is carried out to produce “interpolation” pixel signal for every adjacent four pixel units (in a square). If only two adjacent (left- and right-side) pixel units are used to produce an “interpolation” pixel unit, the group 232b and the corresponding signals are eliminated. Similarly, if only two adjacent (upper- and down-side) pixel units are used to produce an “interpolation” pixel unit, signal HAVE is held in the disabled state to limit interpolation for the left- and right-side pixel units and so on. Accordingly, interpolation for any number of adjacent pixel units and implementation of the corresponding circuit are known by controlling the connecting NMOS switch and capacitor number and the corresponding position and the readout circuit group number.

Interpolation is based on received brightness with the same color and thus the switch mentioned above must connect between two adjacent readout circuit units with the same color representation. The color representation can be achromatic, red, green and blue.

Compared to the prior sub-sampling and interpolating performance in digital domain, the invention performs the interpolation in analog domain through the charge sharing process and thus directly produces “interpolation” pixel signals to form more realistic images and does so better than the prior sub-sampling method. The inventive method does not require high-speed clock and memory for performing the digital interpolation and adds few control circuits and so relatively increasing the entire image processing performance.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the subsequent claims and their equivalents.

What is claimed is:

1. A readout circuit with on-sensor-chip two-dimensional interpolation, comprising:
a plurality of readout units to read received brightness of the pixel units with the same color, each including at least one charge storage device in which stored charge is a received brightness sensed by a corresponding pixel unit, and
a connection switch coupling the charge storage devices to share the charge between the coupled devices before the stored charges are read out, thereby carrying out an xy-interpolation in analog domain.

2. The readout circuit of claim 1, wherein the same color is achromatic, red, green, or blue.

3. The readout circuit of claim 1, wherein the readout units read the received brightness using correlation double sampling (CDS) technique.

4. The readout circuit of claim 1, wherein every readout unit has a reset capacitor and a register capacitor, the reset capacitor to store a reset state of a corresponding pixel unit, the charge storage device being the register capacitor to store a state after the corresponding pixel unit discharges, the readout circuit has a first connection switch to connect the reset capacitors, and a second connection switch to connect the register capacitors.

5. The readout circuit of claim 1, wherein the readout circuits are commonly connected to a column line of a pixel circuit array.

6. The readout circuit of claim 1, wherein the readout circuit units are respectively connected to a plurality of column lines of a pixel circuit array.

7. The readout circuit of claim 1, wherein the connection circuit is a metal oxide semiconductor transistor (MOS).

8. A photo sense module, comprising:
a pixel circuit array, having a plurality of pixel units in an array to detect a same color received brightness;
a readout circuit with optional two-dimensional interpolation function to read the brightness of the pixel units, having:
a plurality of readout unit, each corresponding to one of the pixel units and having at least one charge storage device, wherein stored charge in the charge storage device is a received brightness with respect to one of the pixel units; and
a connection switch coupled between the charge storage devices, to share the stored charge by connecting the charge storage devices before the stored charge is read;
a programmable gain amplifier to amplify an output signal of the readout circuit; and
an analog-to-digital converter to convert the amplified output signal from analog to digital for subsequent digital signal processing, thereby performing two-dimensional interpolation function in analog domain.

9. The photo sense module of claim 8, wherein the same color is achromatic, red, green, or blue.

10. The photo sense module of claim 8, wherein the readout units read the received brightness using correlation double sampling (CDS) technique.

11. The photo sense module of claim 8, wherein every readout unit has a reset capacitor and a register capacitor, the reset capacitor to store a reset state of a corresponding pixel unit, the charge storage device being the register capacitor to store a state after the corresponding pixel unit discharges, the readout circuit has a first connection switch to connect the reset capacitors, and a second connection switch to connect the register capacitors.

12. The photo sense module of claim 8, wherein the readout circuits are commonly connected to a column line of a pixel circuit array.

13. The photo sense module of claim 8, wherein the readout circuit units are respectively connected to a plurality of column lines of a pixel circuit array.

14. The photo sense module of claim 8, wherein the pixel circuit array is a complementary metal oxide semiconductor (CMOS) sensor array.

15. The photo sense module of claim 14, wherein every pixel unit has 3-MOS and a diode.

16. The photo sense module of claim 8, wherein the connection switch is an MOS.

17. A method of producing two-dimensional image, comprising the steps of:
reading every received brightness with the same color, sensed by a plurality of pixel units, in a pixel circuit array, and respectively producing a charge to every received brightness for storing charges to corresponding charge storage devices in a plurality of readout circuits;
averaging the stored charges in the charge storage devices to produce an average charge;
reading out and converting the average charge into a corresponding plurality of digital signals that forms a two-dimensional interpolation image.

18. The method of claim 17, wherein the pixel units are in a same column of the pixel circuit array.

19. The method of claim 17, wherein the pixel units are in a same row of the pixel circuit array.

20. The method of claim 17, wherein the received brightness sensed by the pixel units is read using correlation double sampling (CDS) technique.

21. The method of claim 20, wherein when a pixel circuit array corresponds to the pixel units with the same color, the steps of reading the received brightness sensed by the pixel units are:
reading reset states of the pixel units and thus producing received charges to store in a corresponding plurality of reset capacitors of the readout units; and
reading states after the received charges stored in the readout units are discharged, thus producing corresponding charges to be stored in a corresponding plurality of register capacitors of the readout units.
